(19) United States
(12) Patent Application Publication
(10) Pub. No.: US 2006/0018709 A1
(43) Pub. Date: Jan. 26, 2006

(54) Dual-ended press pin and assembly

(76) Inventors: Alan B. Doerr, Magnolia, TX (US); Minh H. Nguyen, Katy, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/896,457

(22) Filed: Jul. 22, 2004

(51) Int. Cl. F16D 1/00

(52) U.S. Cl. 403/408.1

(57) ABSTRACT

A press pin for mounting in a panel structure comprises a central retaining portion adapted to be inserted into an opening in the panel structure, a first end pin feature protruding from a first side of the central retaining portion, and a second end pin feature protruding from a second side of the central retaining portion.

### BACKGROUND

“Press pins,” or “press-in pins,” are commonly pressed into a panel structure to enable the article to engage or function with an article in an assembly in a prescribed manner. For example, the panel structure and the article may be engaged by being immovably fixed together and spaced apart by the press pin. On the other hand, the article may be able to rotate relative to the panel structure around the press pin. Other manners of engaging two articles by a press pin are also common. Additionally, a wide variety of press pin shapes are available for a wide variety of functions and situations.

The press pin is mounted into a hole in the panel structure. If another press pin is mounted to the panel structure at another hole in order to engage another article, the centerlines of the press pins must be separated by a distance referred to as the “location tolerance.” The location tolerance is primarily governed by the strength and thickness of the material of the panel structure and the anticipated load on the bonds between the panel structure and the press pins. The strength of the bonds between the panel structure and the press pins is primarily determined by the strength and thickness of the materials of the panel structure and of the press pins. The location tolerance, thus, must allow a sufficient amount of the material of the panel structure between the two holes to retain the strength of the bonds between the panel structure and the two press pins. It is, therefore, not possible to engage the two articles coaxially, since the two press pins must be separated by the location tolerance.

### BRIEF DESCRIPTION OF THE DRAWINGS

FIG. 1 is a perspective view of a dual-ended press pin incorporating an embodiment of the present invention.

FIG. 2 is a side view of the dual-ended press pin shown in FIG. 1.

FIG. 3 is a side view of the dual-ended press pin shown in FIG. 1 with a cross sectional view of a panel structure to which the dual-ended press pin may be mounted according to an embodiment of the present invention.

FIG. 4 is a side view of the dual-ended press pin shown in FIG. 1 with a cross sectional view of the panel structure shown in FIG. 3 and a cross sectional view of a punch and an anvil for mounting the dual-ended press pin to the panel structure according to an embodiment of the present invention.

FIG. 5 is a side view of an assembly incorporating an embodiment of the present invention.

FIG. 6 is a perspective view of an assembly incorporating an embodiment of the present invention.

FIG. 7 is a perspective view of a dual-ended press pin incorporating an alternative embodiment of the present invention.

FIG. 8 is a perspective view of a dual-ended press pin incorporating another alternative embodiment of the present invention.

FIG. 9 is a perspective view of a dual-ended press pin incorporating another alternative embodiment of the present invention.

### DETAILED DESCRIPTION

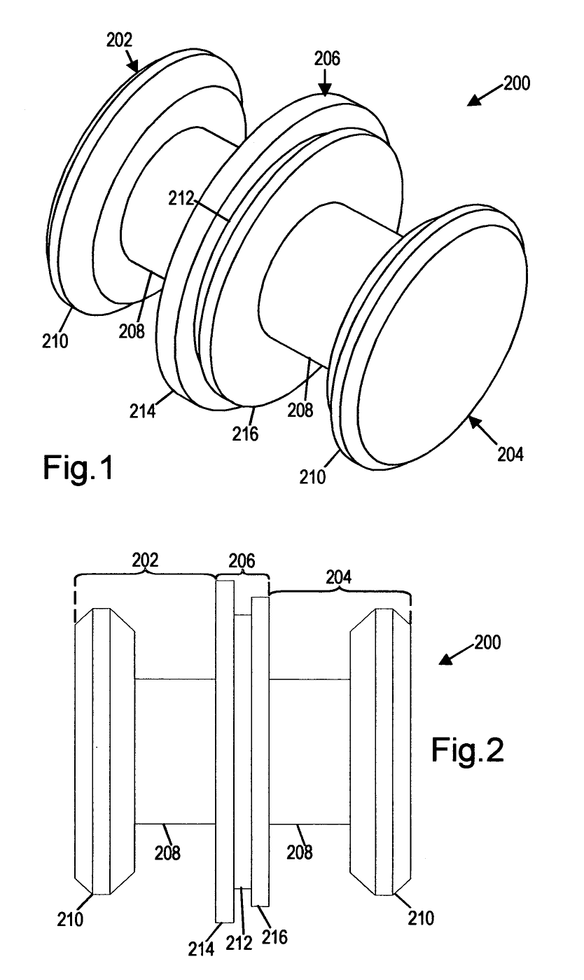

An exemplary dual-ended, or dual-sided, press pin (or “press-in pin”) 200, as shown in FIGS. 1 and 2, generally has two end “pin features” 202 and 204 on opposite sides of a central retaining section, portion or segment 206. The end pin features 202 and 204 are both shown having a spool shape, with a narrow elongated cylindrical portion 208 and a broader shorter end portion 210. However, as will be described below, the end pin features 202 and 204 may have any appropriate shape for the intended function or situation, so the present invention is not limited to the specific end pin features shown herein. Additionally, the central retaining section 206 is shown as generally circular and having a groove 212 between a large retaining wall 214 and a small retaining wall 216. In an alternative embodiment, the central retaining section 206 does not include the groove 212. Additionally, as will be described below, the central retaining section 206 may further have any appropriate shape for the intended function or situation. Thus, the present invention is not limited to the specific central retaining sections shown herein. Furthermore, the dual-ended press pins described herein may be made of any appropriate material, such as metal, plastic, etc.

In the embodiment shown, the end pin features 202 and 204 are coaxial with each other and with the central retaining section 206. In this manner, the dual-ended press pin 200 can be used to coaxially engage two articles on opposite sides of a central panel structure, as described below. The dual-ended and coaxial nature of the press pin 200 is, thus, particularly advantageous in a situation or application having limited available space, so that economy of size or compactness of design is a consideration. Additionally, an assembly can use one component (the dual-ended press pin 200), instead of two or more components, and potentially achieve a simpler and/or smaller design.

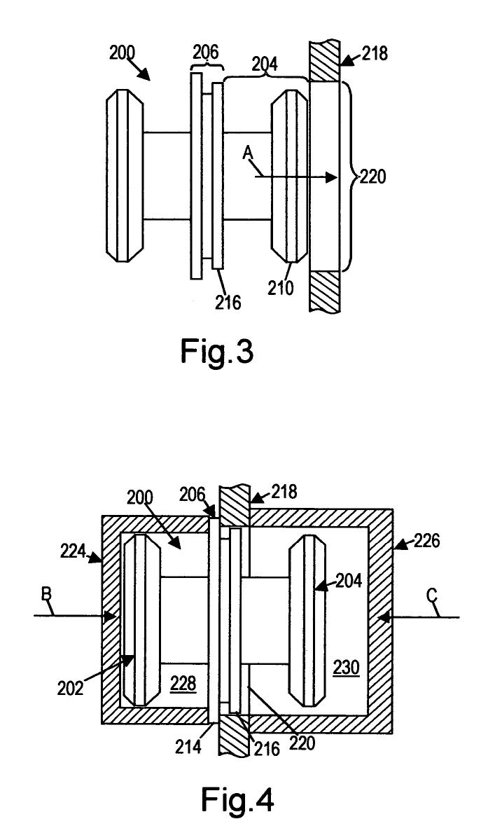

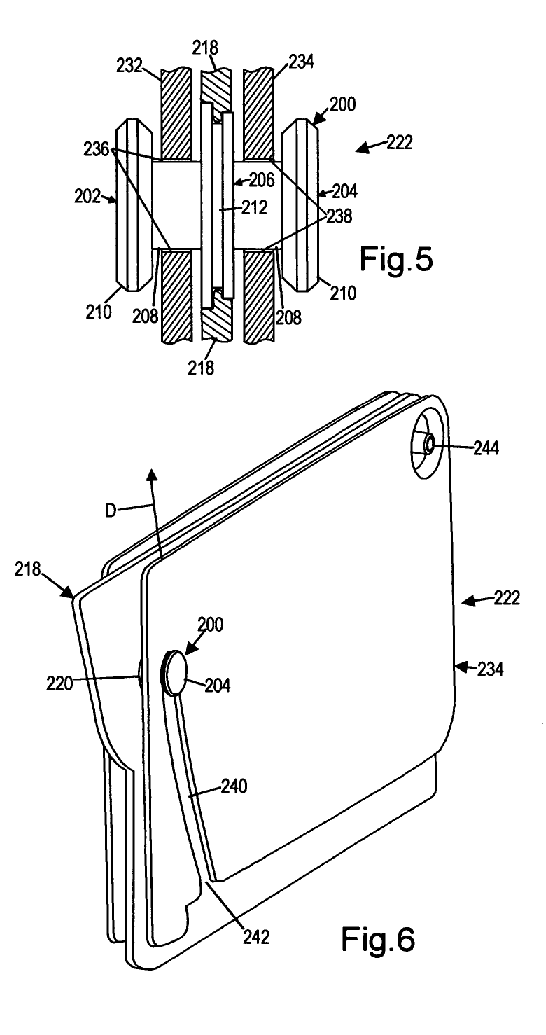

In the embodiment shown, the dual-ended press pin 200 is for mounting in a panel structure 218, as shown in FIGS. 3, 4, 5 and 6. The panel structure 218 may be made of any appropriate material (e.g. metal, plastic, etc.) and has an opening 220 of generally the same shape as the central retaining section 206 of the dual-ended press pin 200. In the embodiment shown, the opening 220 is slightly larger than the end portion 210 of one of the spool-shaped end pin features 204, so that the end portion 210 can be inserted through the opening 220 (in the direction of arrow A, FIG. 3) without undue force, in order to avoid damaging the end portion 210 when constructing an exemplary assembly 222 (FIGS. 5 and 6) that incorporates the dual-ended press pin 200. Additionally, in the embodiment shown, the opening 220 is slightly larger than the small retaining wall 216 of the central retaining portion 206.

To mount the dual-ended press pin 200 to the panel structure 218, the small retaining wall 216 of the central retaining section 206 is inserted into opening 220 and the large retaining wall 214 is held against the panel structure 218 at the opening 220, as shown in FIG. 4, until the central retaining section 206 is pressed or punched into the opening 220. A punch device 224 presses on the central retaining section 206 at the large retaining wall 214 in the direction of arrow B. An anvil 226 presses on the panel structure 218 at the opening 220 in the direction of arrow C. In the embodiment shown, the punch device 224 and the anvil 226, thus, have internal cavities 228 and 230, respectively, that surround the end pin features 202 and 204. The cavities 228 and 230 are sufficiently large that inner walls of the cavities 228 and 230 do not touch the end pin features 202 and 204, in order to avoid damaging the end pin features 202 and 204 or getting them stuck inside the cavities 228 and 230.

The punch device 224 and the anvil 226 operate together to press or punch the central retaining section 206 into the opening 220. Upon doing so, the material of the panel structure 218 at the opening 220 may be slightly deformed, as shown in FIG. 5, to fit partially into the groove 212 of the central retaining section 206. In this manner, the panel structure 218 holds the dual-ended press pin 200 primarily by compression and friction.

To complete construction of the exemplary assembly 222, two side articles 232 and 234 are placed onto the end pin features 202 and 204, respectively. In the example shown, the side articles 232 and 234 may engage the end pin features 202 and 204 in a rotating or a sliding manner, since the side articles 232 and 234 have openings 236 and 238, respectively, slightly larger than the narrow elongated cylindrical portion 208 of the end pin features 202 and 204, as shown in FIG. 5. To install the side articles 232 and 234 onto the end pin features 202 and 204, the side articles 232 and 234 may include a slot 240 with an edge opening 242 (as shown for side article 234 in FIG. 6) at which to slide onto the end pin features 202 and 204 in a sliding manner in the direction of arrow D, e.g. so that the side articles 232 and 234 may pivot relative to the panel structure 218 about point 244. Additionally, the openings 236 and 238 and the width of the slot 240 are smaller than the end portions 210, so the end portions 210 hold the side articles 232 and 234 onto the end pin features 202 and 204.

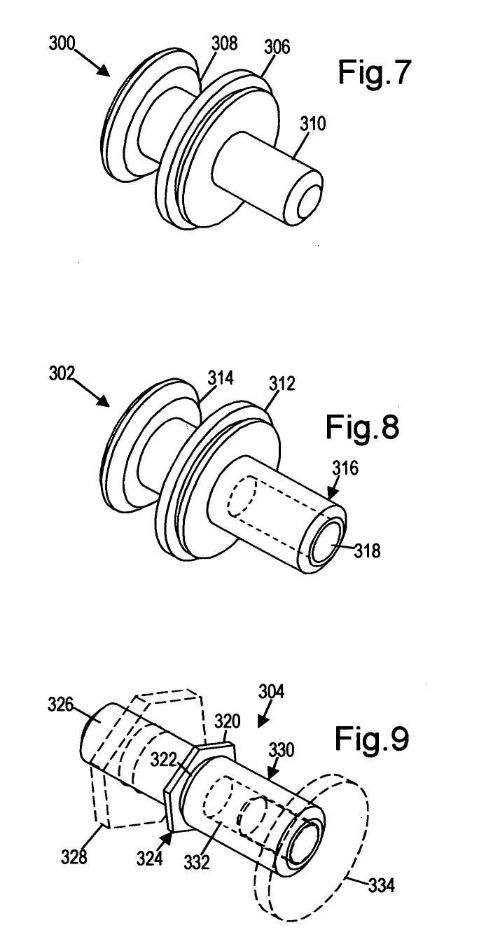

Dual-ended press pins 300, 302 and 304 incorporating exemplary alternative embodiments of the present invention are shown in FIGS. 7, 8 and 9, respectively. These alternative embodiments show some additional variations of end pin features and central retaining sections, and combinations thereof, that may be used in a dual-ended press pin according to the present invention. For example, the dual-ended press pin 300 includes a generally circular central retaining section 306, a spool-shaped first end pin feature 308 and a generally cylindrical second end pin feature 310. The dual-ended press pin 302, on the other hand, also includes a generally circular central retaining section 312 and a spool-shaped first end pin feature 314, but further includes a generally cylindrical second end pin feature 316 with an internal cylindrical cavity 318. Additionally, the dual-ended press pin 304 includes a generally hexagonal wall 320 and cylindrical inner groove 322 in a central retaining section 324, a cylindrical externally threaded first end pin feature 326 (e.g. for receiving a nut 328) and a cylindrical second end pin feature 330 with an internally threaded cylindrical cavity 332 (e.g. for receiving a round-head thumb screw 334).

Each of the end pin features 308, 310, 314, 316, 326 and 330 engages a side article in a different manner. For example, the spool-shaped end pin features 308 and 314 are similar to the end pin features 202 and 204, discussed above, and may engage a side article in a rotating or sliding manner. The cylindrical end pin feature 310 may also engage a side article in a rotating or sliding manner or may allow the side article to slide on and off the cylindrical end pin feature 310. The cylindrical end pin feature 316 with an internal cylindrical cavity 318 may also engage a side article in a rotating or sliding manner and may also allow the side article to slide on and off the cylindrical end pin feature 316, but may also engage the side article by having the side article inserted into the internal cavity 318. The externally threaded end pin feature 326 may engage a side article by clamping down on the side article with the nut 328. The cylindrical end pin feature 330 with an internally threaded cylindrical cavity 332 may engage a side article in a rotating or sliding manner and may allow assembly of the side article to the dual-ended press pin 304 by sliding the side article onto the cylindrical end pin feature 330 followed by securing the side article onto the cylindrical end pin feature 330 by attaching the screw 334. The cylindrical end pin feature 330 may alternatively engage a side article by attaching the side article in the same manner as, and in place of, the screw 334. Having different end pin features on opposite ends of the same dual-ended press pin allows the dual-ended press pin to engage different side articles in different manners.

The embodiment shown in FIGS. 2-6 and the alternative embodiments shown in FIGS. 7, 8 and 9 are not exhaustive of the potential variations for dual-ended press pins that fall within the scope of the present invention. A wide variety of other shapes, profiles, geometries, sizes and functions for end pin features and central retaining sections are possible, including those available for prior art single-ended press pins.

We claim:

1. A press pin for mounting in a panel structure comprising:
a central retaining portion adapted to be inserted into an opening in the panel structure;
a first end pin feature protruding from a first side of the central retaining portion; and
a second end pin feature protruding from a second side of the central retaining portion.

2. A press pin as defined in claim 1 wherein the first and second end pin features are coaxial.

3. A press pin as defined in claim 1 wherein:
the first end pin feature is adapted to engage a first article on a first side of the panel structure in one of a slidable, a rotatable and a fixed manner; and
the second end pin feature is adapted to engage the second article on a second side of the panel structure in one of a slidable, a rotatable and a fixed manner.

4. A press pin comprising:
a central retaining section at which the press pin can be mounted in a panel structure by pressing the central retaining section into the panel structure;
a first pin feature integral with, protruding from and coaxial with the central retaining section and adapted to engage a first article on a first side of the central retaining section; and
a second pin feature integral with, protruding from and coaxial with the central retaining section and adapted to engage a second article on a second side opposite the first side of the central retaining section.

5. A press pin as defined in claim 4 wherein:
the first end pin feature is adapted to engage the first article in one of a slidable, a rotatable and a fixed manner; and
the second end pin feature is adapted to engage the second article in one of a slidable, a rotatable and a fixed manner.

6. A dual-ended press pin, for mounting in a panel structure, comprising:
a means for retaining the dual-ended press pin in an opening in the panel structure;
a first pin means protruding from a first side of the retaining means and for engaging a first article on a first side of the panel structure; and
a second pin means protruding from a second side of the retaining means and for engaging a second article on a second side of the panel structure.

7. A dual-ended press pin as defined in claim 6 wherein the first and second pin means are coaxial.

8. A dual-ended press pin as defined in claim 6 wherein:
the first pin means is for engaging the first article in one of a slidable, a rotatable and a fixed manner; and
the second pin means is for engaging the second article in one of a slidable, a rotatable and a fixed manner.

9. An assembly comprising:
a panel structure having an opening therein; and
a dual-ended press pin comprising a central retaining portion mounted in the opening in the panel structure, a first end pin feature protruding from a first side of the central retaining portion, and a second end pin feature protruding from a second side of the central retaining portion.

10. An assembly as defined in claim 9 further comprising:
a first article engaging the first end pin feature of the dual-ended press pin on a first side of the panel structure; and
a second article engaging the second end pin feature of the dual-ended press pin on a second side of the panel structure.

11. An assembly as defined in claim 10 wherein:
the first end pin feature engages the first article in one of a slidable, a rotatable and a fixed manner; and
the second end pin feature engages the second article in one of a slidable, a rotatable and a fixed manner.

12. An assembly as defined in claim 9 wherein the first and second end pin features are coaxial.

13. An assembly comprising:
a central panel structure;
first and second side articles disposed on first and second opposite sides of the central panel structure;
a means for engaging the central panel structure and the first and second side articles; and
a means for retaining the engaging means in the central panel structure;
and wherein the engaging means comprises:
a first pin means for engaging the first side article on the first side of the central panel structure; and
a second pin means for engaging the second side article on the second side of the central panel structure, the first and second pin means being coaxial.

14. An assembly as defined in claim 13 wherein:
the first pin means engages the first article in one of a slidable, a rotatable and a fixed manner; and
the second pin means engages the second article in one of a slidable, a rotatable and a fixed manner.

15. A method of constructing an assembly comprising:
providing a dual-ended press pin comprising a central retaining portion, a first end pin feature protruding from a first side of the central retaining portion, and a second end pin feature protruding from a second side of the central retaining portion;
mounting the dual-ended press pin in a panel structure by attaching the central retaining portion at an opening in the panel structure, the first and second end pin features being exposed on first and second sides, respectively, of the panel structure;
engaging a first article on the first side of the panel structure by the first end pin feature; and
engaging a second article on the second side of the panel structure by the second end pin feature.
